(19) United States
(12) Patent Application Publication
(10) Pub. No.: US 2004/0225811 A1
(43) Pub. Date: Nov. 11, 2004

(54) Digital addressable lighting interface bridge

(76) Inventor: Ross M. Fosler, Chandler, AZ (US)

Correspondence Address: BAKER BOTTS, LLP, 910 LOUISIANA, HOUSTON, TX, 77002-4995, US

(21) Appl. No.: 09/826,136

(22) Filed: Apr. 4, 2001

(51) Int. Cl. G06F 13/38; G06F 13/40

(52) U.S. Cl. 710/305

(57) ABSTRACT

An interface bridge between a standard input-output (I/O) computer port and a Digital Addressable Lighting Interface (DALI) interface. The DALI bridge translates signal levels and protocol from the standard I/O computer interface port to the DALI signal levels and protocol, and visa-versa. A digital processor is used for protocol translation and message buffering. Signal level translation is used to properly connect to a the computer port and the voltage levels of the two wire DALI bus. Using a standard computer for testing and control of a DALI compliant device and/or plurality of DALI compliant devices in a building lighting system is facilitated by the DALI bridge.

### FIELD OF THE INVENTION

The present invention relates generally to control and status of building lighting and power systems, and more particularly to a bridge between two or more different digital interfaces used for building lighting and power systems.

### BACKGROUND OF THE INVENTION TECHNOLOGY

The demands imposed on lighting systems have changed considerably in recent years. Heretofore, switching individual or groups of luminaries on and off used to be sufficient; however, the focus for today and in the future will be on dynamic lighting. Energy conservation, more flexibility of use, increased life and reduced maintenance costs of lighting systems require lighting scene control. To create lighting scenes, luminaries generally are assigned to a plurality of groups. In addition, an end user preferably wants the option of controlling his or her luminaries. If installations having this type of flexibility are integrated into a building management system, there is also a need for simple check-back of operational status as well as global on/off control.

One method of implementing flexibility in the control of luminaries has been achieved using a new industrial standard for addressable digital lighting control called “Digital Addressable Lighting Interface” or “DALI.” The DALI standard specifies how to control and monitor the status of individual and group addressable lighting equipment such as electronic ballasts and illumination sensors. The DALI standard uses a two wire low voltage control circuit for addressing, controlling and monitoring the status of connected DALI compliant devices. The DALI standard also specifies how to determine the status of the amount of light of addressed luminaries as well as information from fire and security sensors.

DALI compliant electronic ballasts are now being manufactured which comprise all circuitry necessary to control the power to and lighting levels of a connected fluorescent lamp(s). The only connections required to these DALI compliant ballasts are power and a low voltage two wire DALI control circuit. Each DALI compliant ballast also has a unique address as well as being assignable to a group address. These control and address capabilities allow a DALI compliant lighting system to individually control the light level of each the luminaries as well as easily controlling light levels for groups of luminaries.

The DALI messages are serial data streams and comply with a bi-phase, or Manchester, coding in which the bit values “1” and “0” are presented as two different voltage levels, e.g., 16 volts and 0 volts, respectively. The coding includes error detection. A power source is provided to generate the voltage level. DALI interfaces are connected to a two wire control bus which is common to all or groups of DALI interfaces. Each DALI interface receives information by determining the voltage changes representing the bit values, and transmits information by either not clamping a voltage or clamping (shorting) the voltage across the two wire DALI control bus.

DALI messages consist of an address part and a command part (hereinafter “DALI protocol”). The address part determines for which DALI device the message is intended. All DALI devices may execute commands with broadcast addresses. Sixty-four unique addresses are available plus sixteen group addresses. A particular DALI device may belong to more than one group. The light level is defined in DALI messages using an 8-bit number. The value “0” (zero) means that the lamp is not lit. The DALI standard determines the light levels so that they comply with the logarithmic curve in which the human eye observes the light level change in a linear fashion. All DALI ballasts and controllers adhere to the same logarithmic curve irrespective of their absolute minimum level. The DALI standard determines the light levels over a range of 0.1 percent to 100 percent, e.g., level 1 of the DALI standard corresponds to a light level of 0.1 percent.

The DALI protocol and the DALI two wire hardware interface is unique for controlling and monitoring power devices such as lighting. Therefore, as DALI compliant devices and lighting systems become more prevalent, what is needed is a way to easily test, trouble shoot, control and program these DALI devices through standard computer and electronic interfaces.

### SUMMARY OF THE INVENTION

The invention overcomes the above-identified problems as well as other shortcomings and deficiencies of existing technologies by providing a system, method and apparatus for an interface bridge (hereinafter “DALI bridge”) between a standard computer port and a DALI compliant device. The present invention translates signal levels and protocol from a standard computer interface to the DALI signal levels and protocol, and visa-versa. Computer interfaces may be for example, but not limited to, serial RS-232, serial RS-422, parallel, universal serial bus (USB), infrared standard IrDA, Ethernet, Firewire, etc. The present invention is compact, reliable and simple to manufacture. Exemplary embodiments of the invention may be packaged in a connector adapted for attachment to either an appropriate cable for interfacing with an input/output (I/O) port of a computer or directly to the I/O port, and also being adapted for connection to the DALI two wire control bus. Embodiments of the invention may be used in combination with a computer for testing and controlling a single DALI device or a plurality of DALI devices, for example, in a building illumination system.

It is contemplated and within the scope of the present invention that speech recognition and/or generation may be used in combination with a digital signal controller. The digital signal controller may translate verbal commands into DALI compatible commands, and format DALI status information into verbal information.

In accordance with exemplary embodiments of the present invention, an apparatus for bridging a digital interface to a digital addressable lighting interface (DALI) bus, comprises: a digital interface, a digital addressable lighting interface (DALI) interface adapted for connection to a DALI bus, and a processor coupled between the DALI interface and the digital interface. The digital interface is adapted to receive address and control information, the processor formats the received address and control information into a DALI standard format, and the DALI interface is adapted to transmit the DALI standard formatted address and control information onto the DALI bus. The DALI interface may comprise a first switch, the first switch when closed shorts the DALI bus. In addition a power supply may be provided for supplying a voltage on the DALI bus. The DALI bridge may further comprise a second switch, the second switch disconnecting the power supply from the DALI bus when the first switch shorts the DALI bus. The second switch disconnects the power supply from the DALI bus before the first switch shorts the DALI bus. The first switch is normally open and the second switch is normally closed when no address and control information are being sent on the DALI bus. The first switch and the second switch may comprise first and second transistors, respectively. The DALI bridge may further comprise a current limiting circuit coupled to the second transistor for limiting current in the DALI bus when shorted. The DALI bridge may further comprise a sensing circuit for detecting when the DALI bus is shorted. The DALI bridge may further comprise a disconnect circuit for causing the second switch to disconnect the power supply from the DALI bus when a short thereon is detected. The sensing circuit is coupled to the processor so that the processor may determine status information transmitted from a DALI device coupled to the DALI bus. The sensing circuit is coupled to the processor so that the processor may determine status information transmitted from each of a plurality of DALI devices coupled to the DALI bus. The processor formats the DALI device status information from the sensing circuit and sends this status information to the digital interface. The digital interface may be an optically isolated transmitter and receiver adapted for coupling to a computer or digital interface, either serial or parallel.

The present invention is also directed to a method of operation for bridging a digital interface to a digital addressable lighting interface (DALI) bus, the method comprising the steps of: receiving address and control information with a digital interface, formatting the received address and control information into a digital addressable lighting interface (DALI) standard format with a processor coupled to the digital interface, and transmitting the DALI standard formatted address and control information with a digital addressable lighting interface (DALI) interface coupled to the processor. The method further comprises the step of supplying a voltage for a DALI bus. The method further comprises the step of limiting current in the DALI bus. The method further comprises the step of sensing when the DALI bus is shorted. The method further comprises the step of disconnecting the voltage from the DALI bus when the short is detected. The method further comprises the step of sending status information from a DALI device to the digital interface by sensing when the DALI bus is shorted by the DALI device. The method further comprises the step of converting voice commands into the address and control information. The method further comprises the step of generating verbal information corresponding to status information from the DALI device.

In addition, the present invention is directed to a system for bridging a digital interface to a digital addressable lighting interface (DALI) bus connected to at least one DALI device, the system comprising: at least one digital addressable lighting interface (DALI) device connected to a DALI bus, a DALI bridge comprising, a digital interface, a digital addressable lighting interface (DALI) interface connected to the DALI bus, and a processor coupled between the DALI interface and the digital interface, wherein the digital interface is receives address and control information, the processor formats the received address and control information into a DALI standard format, and the DALI interface transmits the DALI standard formatted address and control information onto the DALI bus. The system may be used with an incandescent light, a fluorescent light, a high pressure gas electric discharge light, a low pressure gas electric discharge light, light emitting diode light and electroluminescent light. The system may also be used with a light damper on a window exposed to sunlight, remotely controllable window shades and remotely controllable window curtains. The system may also be used with a smoke detector, a fire detector, a motion detector, a light sensor, a temperature sensor and a humidity sensor. The system may further be connected to a building automation computer system.

A technical advantage of the present invention is easily testing DALI compliant devices with a personal computer.

Another technical advantage is a economically controlling a plurality of DALI devices with a computer system.

Another technical advantage is voice control of a plurality of DALI devices.

A feature of the present invention is flexibility in the application of DALI device control with a computer.

Another feature is translation of standard computer protocols into DALI compliant addresses and commands.

Another feature is optical isolation of a computer interface.

An advantage of the present invention is flexibility in how a DALI device is tested and/or controlled.

Features and advantages of the invention will be apparent from the following description of the embodiments, given for the purpose of disclosure and taken in conjunction with the accompanying drawings.

### BRIEF DESCRIPTION OF THE DRAWINGS

A more complete understanding of the present disclosure and advantages thereof may be acquired by referring to the following description taken in conjunction with the accompanying drawing, wherein:

FIG. 1 illustrates a schematic block diagram of a system using a personal computer for controlling a DALI system through a DALI bridge, according to an exemplary embodiment of the invention;

FIG. 2 illustrates a schematic block diagram of a system using a personal computer, infrared wireless, telephone modem, and/or speech recognition for controlling a DALI system through a DALI bridge, according to another exemplary embodiment of the invention;

FIG. 2A illustrates a schematic block diagram of a system using a personal computer, infrared wireless, telephone modem, and/or speech recognition for controlling a DALI system through a DALI bridge, according to yet another exemplary embodiment of the invention;

FIGS. 3(a)-3(d) illustrate a schematic diagram of an exemplary embodiment of a DALI bridge that may be adapted for use in the systems depicted in FIGS. 1, 2 and 2A;

FIG. 4 illustrates a schematic block diagram of an exemplary embodiment of a program structure for translating various types of input-output commands and status into and from DALI compliant devices; and

FIG. 5 illustrates a schematic flow diagram of exemplary steps used in the program structure depicted in FIG. 4.

While the present invention is susceptible to various modifications and alternative forms, specific exemplary embodiments thereof have been shown by way of example in the drawing and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

The present invention is directed to a method, system and apparatus for an interface-to-interface bridge (hereinafter “DALI bridge”) between a standard computer interface (port) and a Digital Addressable Lighting Interface (DALI) compliant device. The present invention translates signal levels and protocol from a standard computer interface to DALI signal levels and protocol, and visa-versa. Computer interfaces may be for example, but not limited to, serial RS-232, serial RS-422, parallel, Universal Serial Bus (USB), infrared (IrDA), Ethernet, Firewire, etc. Exemplary embodiments of the invention may be packaged in a connector adapted for attachment to either an appropriate cable for interfacing with an input/output (I/O) port of a computer or directly to the I/O port, and also being adapted for connection to the DALI two wire control bus. Embodiments of the invention may be used in combination with a computer for testing and controlling a single DALI device or a plurality of DALI devices, for example, in a building illumination system. It is contemplated and within the scope of the present invention that the DALI bridge may comprise a digital signal controller adapted for translating verbal commands into DALI compatible commands, and format DALI status information into verbal information.

Referring now to the drawings, the details of exemplary embodiments of the present invention are schematically illustrated. Like elements in the drawings will be represented by like numbers, and similar elements will be represented by like numbers with a different lower case letter suffix.

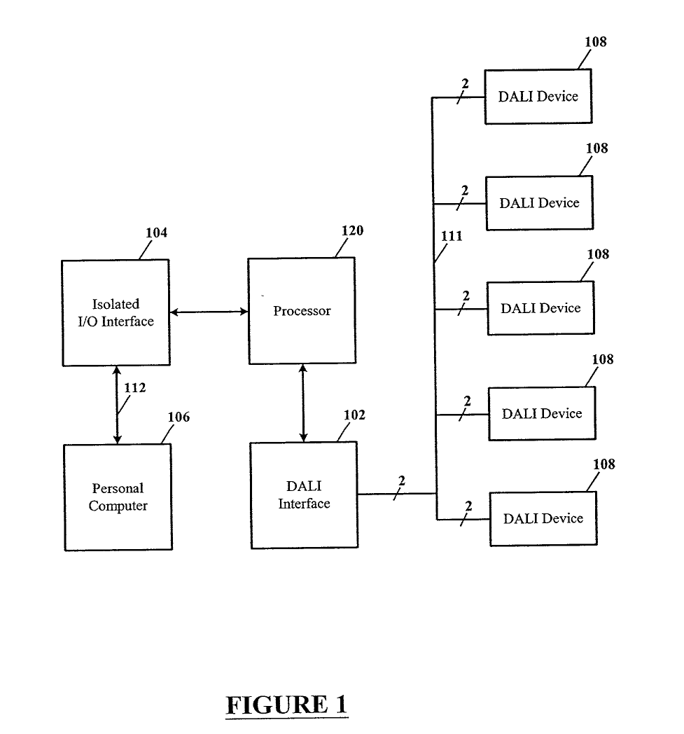

Referring to FIG. 1, depicted is a schematic block diagram of a system using a personal computer for controlling a plurality of DALI compliant devices through a DALI bridge, according to an exemplary embodiment of the invention. The DALI bridge comprises a DALI interface 102, a processor 120 and an isolated input-output (I/O) interface 104. The DALI interface 102 is adapted to interface with a DALI compliant device such as a dimming fluorescent lighting ballast, etc. The processor 120 may be for example, but not limited to, a microcontroller, a microprocessor, a digital signal processor, a digital signal controller, an application specific integrated circuit (ASIC), a programmable logic array (PLA) and the like. An exemplary processor may be a PIC16F627 or PIC16F628 microcontroller by Microchip Technology Inc. The isolated I/O interface 104 is adapted for connection to a personal computer 106 over a communications path 112. The path 112 may be for example, but not limited to, serial RS-232, serial RS-422, parallel, universal serial bus (USB), infrared standard IrDA, Ethernet, Firewire, etc. The path 112 may be electronic signals in conductive wires, light pulses through fiber optic cable, wireless infrared signals (IrDA) and wireless radio frequency signals. The processor 120 may be controlled by a software or firmware program (not illustrated) which is used to control the processor 120 during transmission and translation of signals between the DALI device(s) 108 and the personal computer 106. The DALI bus 111 is a two wire, low voltage, serial digital data communications bus.

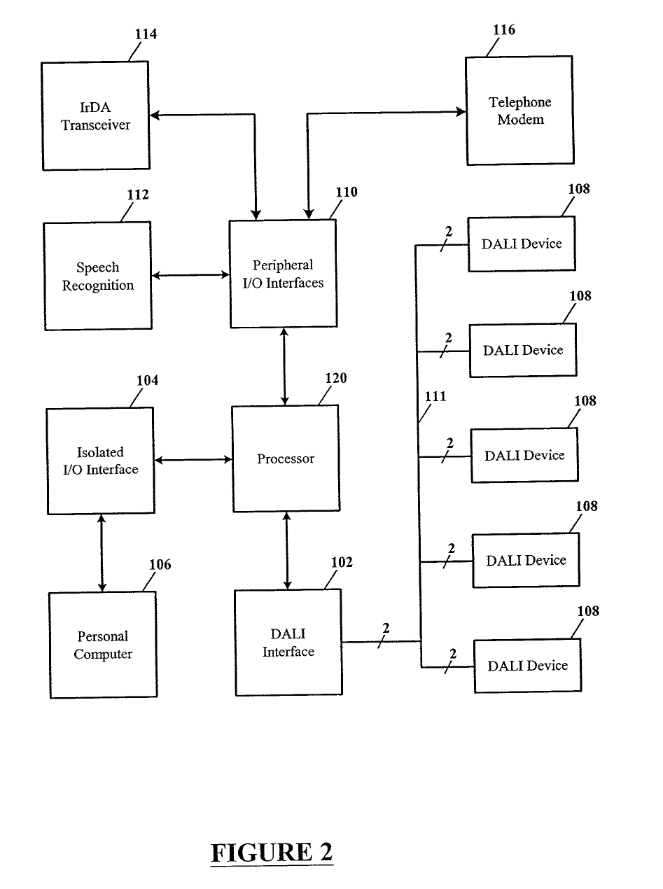

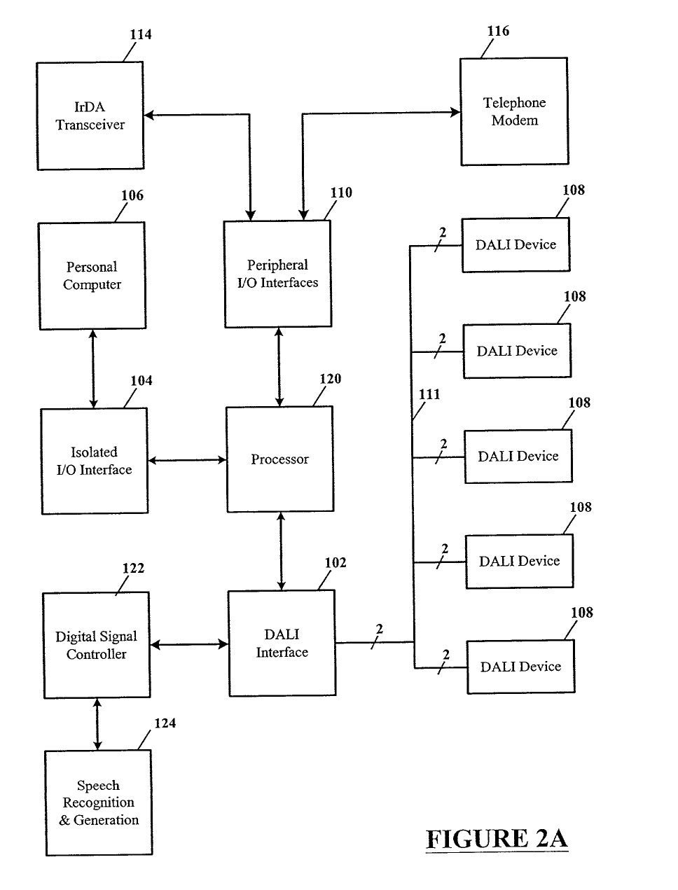

Referring to FIG. 2, depicted is a schematic block diagram of a system using a personal computer, infrared wireless, telephone modem, and/or speech recognition for controlling a DALI system through a DALI bridge, according to another exemplary embodiment of the invention. In addition to the functions and features illustrated in FIG. 1, the DALI bridge depicted in FIG. 2 further comprises peripheral I/O interfaces 110, a telephone modem 116 and infrared transceiver (IrDA) 114 and speech recognition logic 112. The I/0 interface 110 is adapted for connection to one or more different peripherals, e.g., 112, 114 and 116. The IrDA transceiver 114 is adapted for communications with a remote control infrared device (not illustrated) for control of the DALI devices 108. The speech recognition logic 112 is adapted for receiving voice commands for controlling the DALI devices 108.

Referring to FIG. 2A, depicted is a schematic block diagram of a system using a personal computer, infrared wireless, telephone modem, and/or speech recognition for controlling a DALI system through a DALI bridge, according to yet another exemplary embodiment of the invention. In addition to the functions and features illustrated in FIG. 2, the DALI bridge depicted in FIG. 2A further comprises a speech recognition and generation circuit 124 and a digital signal controller 122. The speech recognition and generation circuit 124 in combination with the digital signal controller 122 is adapted for receiving voice commands for controlling the DALI devices 108 and for annunciating the status of the DALI devices 108. The digital signal controller 122 may be adapted for translating the voice command signals from the speech recognition and generation circuit 124 so as to control the DALI devices 108 through the DALI interface 102.

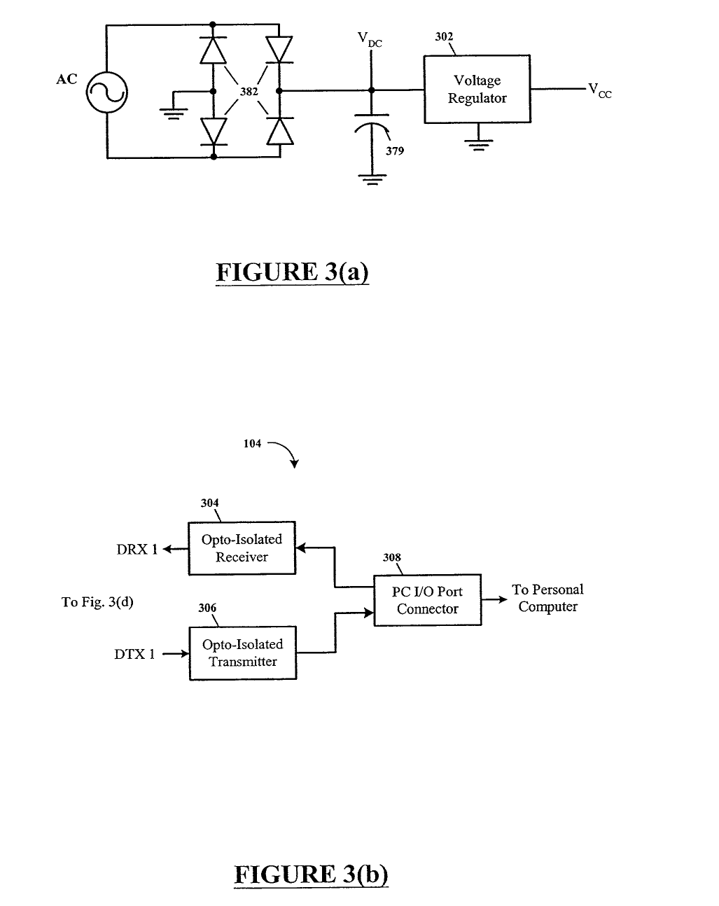

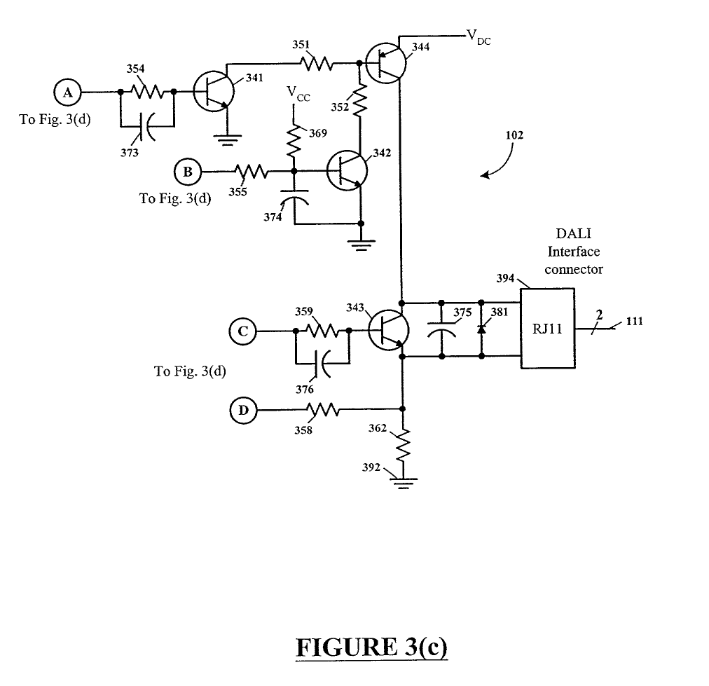

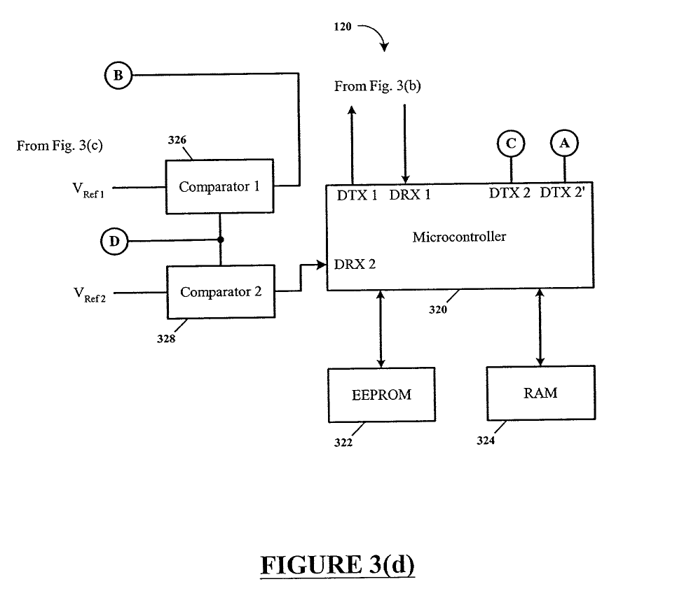

Referring now to FIGS. 3(a)-3(d), depicted is a schematic diagram of an exemplary embodiment of a DALI bridge that may be adapted for use in the systems depicted in FIGS. 1, 2 and 2A. FIG. 3(a) illustrates a power source for the DALI bridge (and DALI bus) which comprises a full wave diode bridge rectifier 382, a filter capacitor 379 and a voltage regulator 302. The power source of FIG. 3(a) may be powered by a low voltage alternating current (AC) source. A switching power supply may also be utilized that may be directly connection to line voltages and the switching power supply may be double insulated or grounded according to the National Electrical Code, Underwriters Laboratories, etc. An isolation transformer (not illustrated) may be utilized to step down the AC input voltage to the rectifier 382. The voltage regulator 302 uses the rectified voltage V_{DC} to produce the voltage V_{CC}. The voltage regulator 302 may be for example any three terminal voltage regulator e.g., 5 volts, 3 volts, 1.6 volts, etc. V_{DC} is selected to be compatible with the DALI interface voltage requirements, and V_{CC} is selected to be compatible with the digital electronics herein described (e.g., 5 volts, 3 volts, 1.6 volts).

Referring to FIG. 3(b), depicted is a functional schematic block diagram of an exemplary embodiment of the isolated I/O interface 104. The isolated I/O interface 104 comprises a PC I/O port connector 308, an opto-isolated receiver 304 and an opto-isolated transmitter 306. The purpose of the isolated I/O interface 104 is to prevent ground loops between the DALI bridge and the personal computer 106 and for logic level voltage translation.

Referring to FIG. 3(c), depicted is a schematic diagram of an exemplary embodiment of the DALI interface 102. The DALI interface 102 is adapted to supply bus voltage to the DALI bus 111. Transistor 344 drives the DALI bus 111 to V_{DC} and supplies a limited amount of current, e.g., no more than 250 milliamperes, to the DALI bus 111 when another DALI device shorts out the bus 111 during signaling conditions, in accordance with the DALI specification. V_{DC} may be from about 14 to 26 volts DC. Transistor 343 turns on and creates a low resistance path between the two wires of the DALI bus 111 during the transmission of serial pulses comprising the address and data information to the DALI devices 108. Transistor 342 is used to turn off the transistor 344 before the transistor 343 turns on so as to reduce the amount of current drawn through the transistor 344. Resistor 355 and capacitor 374 form a timing current for turning on and off the transistor 342.

Exemplary component values for the circuit of FIG. 3(c) are: resistor 354 4.7 kohm; capacitor 373=100 pf; transistors 341, 342 and 343=2N4401; transistor 344=2SB947; resistor 351=4.7 kohm; resistor 352=10 kohm; resistor 369=47 kohm; resistor 355=2.2 kohm; capacitor 374=1 microfarad; resistor 359=1 kohm; capacitor 376=100 pf, resistor 362=1 ohm; resistor 358=10 kohm; and capacitor 375=0.01 microfarad.

Transmit signals are placed on node A and node C. A transmit signal is placed on node A and turns transistor 344 on and off during address and command signaling to the DALI devices 108. Transistor 344 serves as an active “pull-up” to V_{DC}. A transmit signal is also placed on node C which turns transistor 343 on and off during signaling to the DALI devices 108. Transistor 343 serves as an active “pull-down” to ground 392. A signal from the first comparator 326 is placed on node B and turns off transistor 342 when a certain maximum threshold current through the DALI bus 111 occurs. This reduces the amount of current drawn during the communications with the DALI devices 108. Nodes A and B are used to control turn on and off of transistor 344, and node C is used to control turn on and turn off of the transistor 343. An advantage of the DALI interface depicted in FIG. 3(c) is that the voltage source V_{DC} is cut off (through transistor 344) before the DALI 111 wires are shorted together (through transistor 343). This “break before make” operation sequence reduces the amount of current that must flow through the transistors and thus reduces the power dissipation (heat) of this circuit. Node D represents the amount of current being drawn by either a DALI device 108 sending status information or the DALI bridge 102 transmitting control information on the DALI bus 111. A voltage drop across the resistor 362 is proportional to the current in the DALI bus 111.

Referring to FIG. 3(d), depicted is a processor 320 having a first comparator 326 and a second comparator 328, an EEPROM 322 and RAM 324. The EEPROM 322 may store a program for the processor 320. The comparators 326 and 328 monitor the voltage at node D. The voltage at node D is proportional to the current through the resistor 362. The first comparator 326 applies an average voltage to node B. A current is pulled through transistor 342 that is proportional to the average voltage at node B. The average current through transistor 342 is proportional to the voltage across resistor 362. For example, when the resistor 362 is 1 ohm, V_{ref1} may be selected for a voltage value of 0.24 volts and V_{ref2} may be selected for a voltage value of 0.2 volts. If the current through the resistor 362 exceeds 240 milliamperes, then the first comparator 326 will generate an average voltage on node B. When the voltage across the resistor 362 is greater than 0.2 volts, the second comparator 328 signals the processor 320 that a DALI device 108 is signaling or the DALI wires are shorted.

The processor 320 receives serial data at DRX1 from the isolated I/O interface 104 or from the peripheral I/O interface 110, reformats this received serial data to DALI serial information, then transmits the DALI serial data from DTX2. The processor 320 also receives serial status data at DRX2 from a DALI device 108 (second comparator 328) reformats this received DALI serial status data, then transmits the reformatted information from DTX1.

Node B generates an average voltage for current regulation. When not regulating and not transmitting data node B is high, allowing the transistor 344 to supply current to the DALI bus 111. When transmitting node B is low. Thus transistors 342 and 344 are turned off. V_{ref1} is the voltage regulation reference. Node A is used for transmitting data on the DALI bus 111.

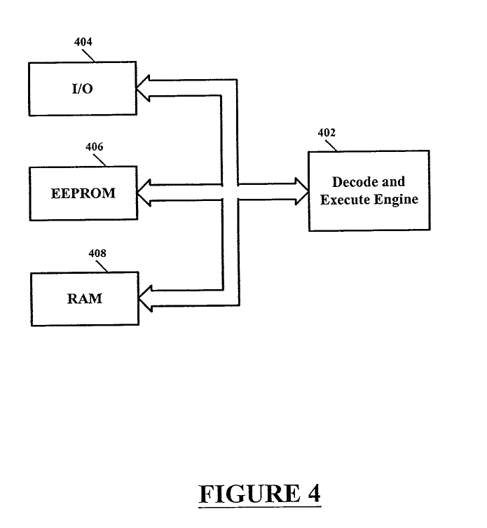

FIG. 4 represents a program structure on how memory is managed for programs to execute. For example, the decode and execute engine 402 can execute instructions that are stored in the EEPROM 406. The EEPROM 406 may store an interpretive language code. The decode and execute engine 402 can also execute instructions that are stored in the RAM 408. The decode and execute engine 402 can also execute instructions that are streamed in on the I/O port 404. The decode and execute engine 402 can use the RAM 408 as working area for variables. The decode and execute engine 402 can use the EEPROM 406 as a storage area for constants. The decode and execute engine 402 can use the I/O interface 404 for receiving and sending data outside of the DALI bridge 102. The I/O interface 404 is memory area where all external data is transferred. This may include the DALI devices 108, a personal computer 106, IRDA transceiver 114, a telephone modem 116, a digital signal controller 122 or speech recognition 112, a Universal Serial Bus (USB) (not illustrated) and the like. The decode and execute engine 402 may be used as the main processing unit for the DALI bridge 102.

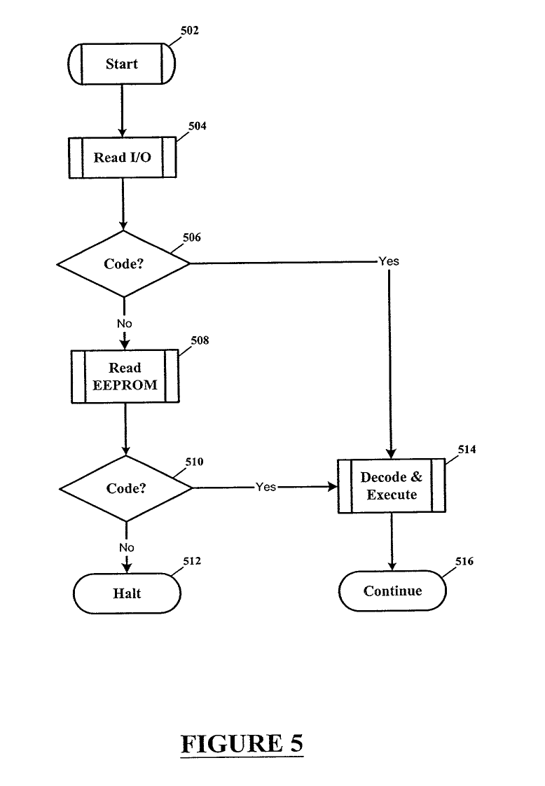

FIG. 5 depicts a schematic flow diagram of exemplary program steps used with the program structure illustrated in FIG. 4. Program code execution is not limited to just operation from the EEPROM storage area. The code may be executed from the RAM 408 or from any of the I/O interfaces. Thus, a program need not be stored in any particular place for operation of the DALI bridge 102. This feature of the invention allows greater flexibility and cost savings without limiting capabilities. The flow diagram depicted in FIG. 5 illustrates how a program startup may occur. Code execution can start from either I/O or EEPROM. Preferably, the current running program would transfer execution to other sources such as RAM or other I/O.

Referring to FIG. 5, in step 502 the decode and execute engine 402 begins startup by reading the I/O port 404 in step 504 to determine, in step 506, if there is program code present. If code is present then Step 506 directs the decode and execute engine 402 to decode and execute the code in step 514. The program runs in step 516. If no program code is detected in step 506, the decode and execute engine 402 is directed to read the EEPROM 406 in step 508. In step 510, it is determined whether there is program code in the EEPROM 406. If there is no program code then this operation halts at step 512. If there is program code then the decode and execute engine 402 is instructed in step 514 to decode and execute the code in the EEPROM 406. The program runs in step 516.

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. An apparatus for bridging a digital interface to a digital addressable lighting interface (DALI) interface, comprising:
a digital interface;
a digital addressable lighting interface (DALI) interface adapted for connection to a DALI bus; and
a processor coupled between said DALI interface and said digital interface, wherein said digital interface is adapted to receive address and control information, said processor formats the received address and control information into a DALI standard format, and said DALI interface is adapted to transmit the DALI standard formatted address and control information onto the DALI bus.

2. The apparatus of claim 1, wherein said digital interface is selected from the group consisting of serial RS-232, serial RS-422, parallel, Universal Serial Bus (USB), infrared (IrDA), ethernet and firewire.

3. The apparatus of claim 1, wherein said processor is selected from the group consisting of a microcontroller, a microprocessor, a digital signal processor, a digital signal controller, an application specific integrated circuit (ASIC) and a programmable logic array (PLA).

4. The apparatus of claim 1, wherein said DALI interface comprises a first switch, said first switch when closed shorts the DALI bus.

5. The apparatus of claim 4, further comprising a power supply for supplying a voltage on the DALI bus.

6. The apparatus of claim 5, further comprising a second switch, said second switch disconnecting said power supply from the DALI bus when said first switch shorts the DALI bus.

7. The apparatus of claim 6, wherein said second switch disconnects said power supply from the DALI bus before said first switch shorts the DALI bus.

8. The apparatus of claim 7, wherein said first switch is normally open and said second switch is normally closed when no address and control information are being sent on the DALI bus.

9. The apparatus of claim 8, wherein said first switch and said second switch comprise first and second transistors, respectively.

10. The apparatus of claim 9, further comprising a current limiting circuit coupled to said second transistor for limiting current in the DALI bus when shorted.

11. The apparatus of claim 1, further comprising a sensing circuit for detecting when the DALI bus is shorted.

12. The apparatus of claim 11, further comprising a disconnect circuit for causing said second switch to disconnect said power supply from the DALI bus when a short is detected on the DALI bus.

13. The apparatus of claim 11, wherein said sensing circuit is coupled to said processor so that said processor may determine status information transmitted from a DALI device coupled to the DALI bus.

14. The apparatus of claim 13, wherein said sensing circuit is coupled to said processor so that said processor may determine status information transmitted from each of a plurality of DALI devices coupled to the DALI bus.

15. The apparatus of claim 13, wherein said processor formats the DALI device status information from said sensing circuit and sends this status information to said digital interface.

16. The apparatus of claim 1, wherein said digital interface comprises an optically isolated transmitter and receiver.

17. The apparatus of claim 1, wherein said digital interface is adapted for connection to a computer.

18. The apparatus of claim 17, wherein said computer is a personal computer.

19. The apparatus of claim 1, further comprising a speech recognition circuit, said speech recognition circuit is adapted for converting voice commands into the address and control information.

20. The apparatus of claim 19, wherein said speech recognition circuit is coupled to said digital interface.

21. The apparatus of claim 19, wherein said speech recognition circuit is coupled to said processor.

22. The apparatus of claim 13, further comprising a speech generation circuit, said speech generation circuit is adapted to generate verbal information corresponding to the status information from the DALI device.

23. The apparatus of claim 1, further comprising:
a speech recognition and generation circuit; and
a digital signal controller, wherein said a speech recognition and generation circuit is coupled to said digital signal controller and said digital signal controller is coupled to said DALI interface.

24. A method for bridging a digital interface to a digital addressable lighting interface (DALI) interface, said method comprising the step of:
receiving address and control information with a digital interface;
formatting the received address and control information into a digital addressable lighting interface (DALI) standard format with a processor coupled to said digital interface; and
transmitting the DALI standard formatted address and control information with a digital addressable lighting interface (DALI) interface coupled to said processor.

25. The method of claim 24, wherein said digital interface is selected from the group consisting of serial RS-232, serial RS-422, parallel, Universal Serial Bus (USB), infrared (IrDA), ethernet and firewire.

26. The method of claim 24, wherein said processor is selected from the group consisting of a microcontroller, a microprocessor, a digital signal processor, a digital signal controller, an application specific integrated circuit (ASIC) and a programmable logic array (PLA).

27. The method of claim 24, further comprising the step of supplying a voltage for a DALI bus.

28. The method of claim 27, further comprising the step of limiting current in the DALI bus.

29. The method of claim 27, further comprising the step of sensing when the DALI bus is shorted.

30. The method of claim 29, further comprising the step of disconnecting the voltage from the DALI bus when the short is detected.

31. The method of claim 29, further comprising the step of sending status information from a DALI device to said digital interface by sensing when the DALI bus is shorted by the DALI device.

32. The method of claim 24, further comprising the step of converting voice commands into the address and control information.

33. The method of claim 31, further comprising the step of generating verbal information corresponding to status information from the DALI device.

34. A system for bridging a digital interface to a digital addressable lighting interface (DALI) interface connected to a DALI bus having at least one DALI device, said system comprising:
at least one digital addressable lighting interface (DALI) device connected to a DALI bus;
a DALI bridge comprising,
a digital interface;
a digital addressable lighting interface (DALI) interface connected to the DALI bus; and
a processor coupled between said DALI interface and said digital interface, wherein said digital interface receives address and control information, said processor formats the received address and control information into a DALI standard format, and said DALI interface transmits the DALI standard formatted address and control information onto the DALI bus.

35. The system of claim 34, wherein said digital interface is selected from the group consisting of serial RS-232, serial RS-422, parallel, Universal Serial Bus (USB), infrared (IrDA), ethernet and firewire.

36. The system of claim 34, wherein said processor is selected from the group consisting of a microcontroller, a microprocessor, a digital signal processor, a digital signal controller, an application specific integrated circuit (ASIC) and a programmable logic array (PLA).

37. The system of claim 34, wherein said DALI device is selected from the group consisting of a incandescent light, a fluorescent light, a high pressure gas electric discharge light, a low pressure gas electric discharge light, light emitting diode light and electroluminescent light.

38. The system of claim 34, wherein said DALI device is selected from the group consisting of a light damper on a window exposed to sunlight, remotely controllable window shades and remotely controllable window curtains.

39. The system of claim 34, wherein said DALI device is selected from the group consisting of a smoke detector, a fire detector, a motion detector, a light sensor, a temperature sensor and a humidity sensor.

40. The system of claim 34, wherein said DALI bridge is connected to a building automation computer system.
